(19) United States
(12) Patent Application Publication
(10) Pub. No.: US 2007/0294166 A1
(43) Pub. Date: Dec. 20, 2007

(54) Add on investment technology and purchase plus

(76) Inventor: Phil Cello, Fairfield, CA (US)

Correspondence Address: DERGOSITS & NOAH LLP, FOUR EMBARCADERO CENTER, SUITE 1450, SAN FRANCISCO, CA, 94111, US

(21) Appl. No.: 11/820,112

(22) Filed: Jun. 18, 2007

Related U.S. Application Data
(60) Provisional application No. 60/814,839, filed on Jun. 17, 2006.

(51) Int. Cl. G06Q 40/00

(52) U.S. Cl. 705/40

(57) ABSTRACT

A system, software product and process for enabling automated investment of funds is disclosed. Using current and existing bank accounts, account holders can debit from or charge to these accounts during normal day-to-day transactions. The transaction amount may be rounded or incremented up to a preset multiple, such as the next dollar, five dollars or ten dollars up. The transaction amount may be rounded-up to a preset percentage. The amount of rounded-up dollars is automatically allocated for distribution to an investment account, while the transaction amount is transferred to the acquiring merchant. By using this service, the account holder automatically creates funds for distribution to an investment portfolio or savings account, without having to actively divert income. In addition, the account holder may choose to divert funds to other financial accounts for non-investment purposes.

### RELATED APPLICATION DATA

This nonprovisional utility patent application claims priority under 35 U.S.C. §119(e)(1) to provisional patent application No. 60/814,839, filed on Jun. 17, 2006.

### TECHNICAL FIELD

The present invention relates generally to asset management, and specifically, to a process and process for automatically generating funds for investment during any type of transaction.

### BACKGROUND OF THE INVENTION

Saving or investing for the future continues to be an unmet goal for many. People seem to be unable or unwilling to apportion their income for savings. As a result, during times of economic downturn or lessened income expectations, these people are left without a financial safety blanket. In the retirement years, the consequences of this problem becomes more evident, forcing some to work beyond the age of retirement, and/or rely upon other family members and the government for support.

There have been many proposed solutions for this problem, including public service announcements and advertising of various investment products. The government provides tax incentives for saving in various retirement accounts, and many banks offer passive investment services by allowing its customers to periodically apportion a percentage of a directly deposited paycheck into a savings and/or retirement account. While these proposals have met with some success, there is still ample room for improvement. Savings account allocation using existing processs can be too slow to generate any significant investment capital. What is needed is a better way to generate savings for those with little to no interest in active investment allocation management. What is further needed is a way to build investment capital using daily transactions.

One proposal may be to provide for an automated investment plan that permits the passive investment of funds expended at the point of sale. By uniting with a person's existing debit card account, purchases made using the debit card could be rounded-up to the nearest dollar amount. The difference between the rounded-up amount and the amount actually owed to a merchant could be deposited into another account at the debit card's issuing bank. These deposits could be distributed to a saving or investment vehicle automatically, requiring little effort from the account holder. However, an issue with this proposal might be the limitation to a single bank. What is needed is a way to permit investment at a network of asset management firms, so that, if desirable, the person has the opportunity to find the best investment vehicle for distributed funds in order to maximize return. What is further needed is a way to permit enrollment of a number of accounts owned by an account holder. The typical consumer possesses more than one debit card account—it would be desirable if the consumer could cause passive automatic investment from all these different accounts.

Another weakness in current process might be the limitation of rounding up to the next whole dollar. What is needed is a way to allow transaction amounts to be rounded-up to other multiples or increments, so that the account holder has the opportunity to invest larger fund amounts.

### SUMMARY OF THE INVENTION

What is disclosed is a system, software program and process for allowing passive automatic investment of funds expended at any transaction. According to one embodiment of the present invention, a user enrolls in a service and registers at least one account from an issuing bank. This issuing bank account may be a credit, debit, or checking service. When an enrollee pays with a registered account at a transaction, the transaction may be flagged by an embodiment of the present invention. The merchant at the transaction may be paid by the issuing bank for the registered account. The transaction may be rounded-up to a multiple set by the enrollee, the service provider or the issuing bank. The difference between the rounded-up amount and the actual transaction amount will be earmarked for transfer. In one embodiment of the present invention, the difference between the rounded-up amount and the actual transaction amount is transferred to an investment account of the enrollee's choosing. In another embodiment, this amount is transferred to an investment product offered by the service provider, the issuing bank or another asset management firm. In a further embodiment, this amount is transferred to holding account for enrollee's private use. The present invention may also permit pooling of different enrollee transactions so that a group of enrollees can contribute to the same investment account.

An embodiment of the present invention may provide services for monitoring point of sale transactions using registered accounts, rounding up actual transaction amounts, and transferring funds to asset management firms.

### BRIEF DESCRIPTION OF THE FIGURES

FIG. 1 is an exemplary block diagram showing the possible hardware components of one embodiment of the present invention.

FIG. 2 is an exemplary flow diagram showing the steps of one embodiment of the present invention.

### DETAILED DESCRIPTION OF THE INVENTION

What is disclosed is a system and process for automatically generating funds for investment by leveraging existing transactions at the point of sale. For purposes of this disclosure, an investment account includes a savings account or any type of holding account for funds that may or may not appreciate in value.

In one embodiment of the present invention, account holders are enrolled in an automated investment program by registering certain existing bank card products issued by certain banks (“registered account”). During a point of sale transaction, the enrolled account holder (“enrollee”) presents one of the registered bank cards to the merchant for payment of the transaction amount. If funds permit, the transaction amount will be rounded-up to a preset increment. The merchant will receive payment for the transaction amount, and the enrolled account holder will receive the rounded-up amount as funds deposited to a savings or investment account. One will appreciate that an enrollee may hold multiple bank card and/or investment accounts that can take advantage of the features of the present invention.

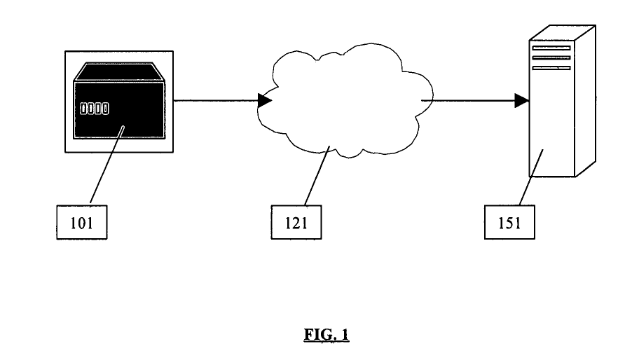

In one embodiment of the present invention, the service for managing the rounding up of transaction amounts and transferring rounded-up funds to investment accounts might be a single entity. This may require adapting the present invention to work in conjunction with an issuing bank, which issues the bank cards that will effect transactions, and/or an acquiring bank, which passes along requests for payment from a requesting party to the paying party or issuing bank. In one embodiment, this might be accomplished through the use of various computer hardware and software resources. For example, as shown in FIG. 1, a point of sale device or computer 101 connected over a network 121 to a server computer 151 that stores enrollee profile information may be required. An enrollee profile may include account information for the one or more registered issuing bank card or checking products used by the enrollee. Such account information, according to one embodiment, may include an account number, the issuing bank where the account is held and the enrollee's name. One skilled in the relevant art will appreciate that certain other information may also be stored on the server 151. Transactions may only be successful if an enrollee's account has sufficient funds; however, if an overdraft protection mechanism is in place, then the server computer 151 may store this information with the enrollee's profile. In addition, the server computer may store an enrollee's preferences. The server 151 may be encrypted to protect enrollee data.

In one embodiment of the present invention, the point of sale device 101 may be an electronic cash register linked to a debit or credit card reader or check reader, or any other type of financial transaction device used during point of sale transactions. The point of sale device 101 may have PIN pad, biometric or other type of input mechanism for the identification of the payer and the payer's accounts. One skilled in the relevant art will appreciate that the point of sale device 101 may be located at a place of business where the enrollee goes to purchase merchandise.

One will appreciate that the server 151 may be a single computer or distributed across more than one computer, accessible through a network 121. The server 151 may receive transaction information from point of sale transactions over the internet, or through a closed intranet. It may communicate directly with the point of sale transaction computers, or it may monitor transactions at the issuing bank to see if registered accounts are used. One skilled in the art will recognize that the terms “network,” “computer network,” and “online” may be used interchangeably and do not imply a particular network embodiment or topography. In general, any type of network (e.g., LAN, WAN, SAN or Internet) may be used to implement the online or computer networked embodiment of the present invention. The network may be maintained by a server, or the network may be serverless. Similarly, any type of protocol (e.g., HTTP, FTP, ICMP, UDP, WAP, SIP, H.323, NDMP, TCP/IP) may be used to communicate across the network.

One will also appreciate that the embodiments disclosed herein are merely exemplary, and are not meant to be limiting in any way. The present invention is not limited to any specific combination of hardware circuitry and software, nor to any particular source for the instructions executed by the server or data sources. Numerous other embodiments of the present invention may exist without departing from the spirit of the present invention. For example, while an embodiment of the present invention is described in the context of a point of sale transaction, one will appreciate that aspects of the present invention apply whenever an enrollee pays with a registered account.

Enrollment for the service feature of the present invention may require accessing a website on the internet or through an intranet, and registering one or more accounts. This website may be branded by any bank involved in the transaction, but the service may be united under a single brand name, such as Purchase Plus. In one embodiment of the present invention, an enrollee may need to provide account information for the account to be registered, and the account to which funds are transferred after rounded-up funds are tallied. In another embodiment, enrollment is accomplished at the issuing bank, performed with the aid of bank personnel at a local bank branch terminal. A new account holder or existing account holder may be given the option to register the account with the service. Aspects of the enrollment and account registration process may be implemented by software stored in memory and executed by a processor, such as a computer. In another embodiment, aspects of the enrollment and account registration process may be performed by hardware, software, or any combination of hardware and software.

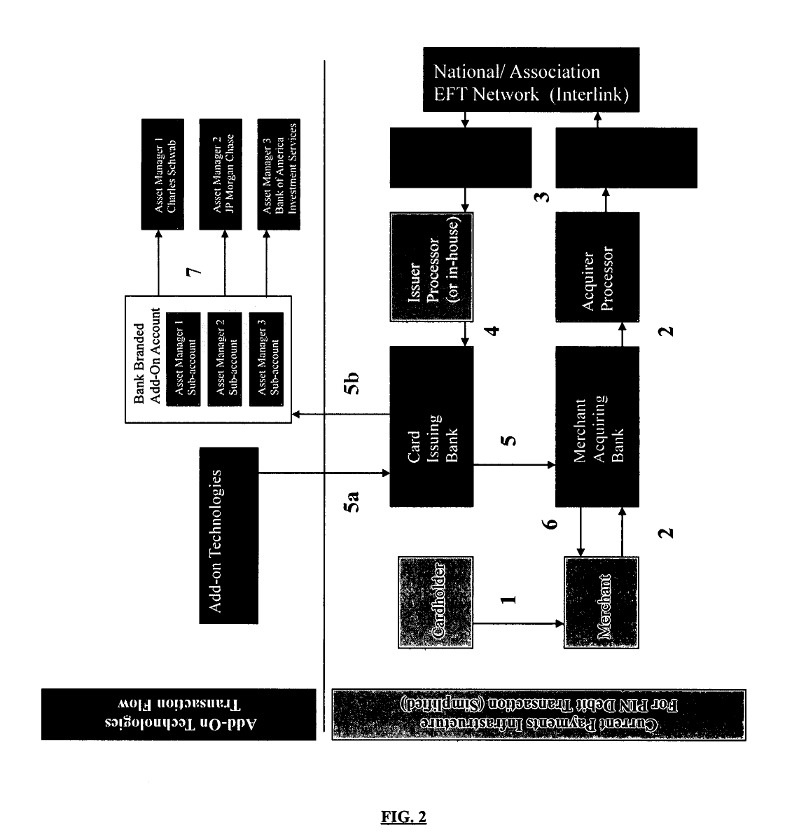

Once registered, the registered account may be used to distribute rounded-up funds to an investment account, which may be the issuing bank, the registering bank, or any asset management firm of the account holders choosing. One skilled in the relevant art will recognize that a number of options may be available to the enrollee to provide investment capital or other funds. FIG. 2 depicts an embodiment of the present invention as a possible transaction flow for an enrolled account holder with a registered bank card at a retail point of sale. These steps may be performed in whole or in part by the various hardware and software components that may comprise an embodiment of the present invention. One will appreciate that while a bank debit card is used as an example in FIG. 2, the transaction flow may be modified for checking or credit card transactions.

In a step 1, an enrollee cardholder presents a registered bank card to pay for merchandise at the point of sale. In a step 2, the point of sale device (101 of FIG. 1) relays a message to the merchant's acquiring bank or merchant acquirer processor. In a step 3, the merchant processor routes information through a network to an issuing processor. In one embodiment of the present invention, the information is routed through a regional electronic funds transfer (EFT) network. In another embodiment, the information is routed through a national EFT network, such as Interlink. In a step 4, the processor notifies the issuing bank of the transaction, and in this embodiment, debits the respective account immediately. Alternatively, funds within the enrollee's account could be placed on hold, restricting use of these funds reserved for payment of merchandise. In a step 5, at the end of the business day, the issuing bank settles accounts with the merchant acquiring bank, depositing the transaction funds for the merchandise into the merchant account. In a step 5a, rounding rules are passed to the issuing bank for each enrolled cardholder. Further, in a step 5b, the issuing bank transfers rounded amounts into a separate account. In a step 6, the merchant receives funds from the merchant account. In a step 7, rounded-up funds from the separate account are routed to the asset management accounts.

An aspect of the present invention provides the rounding, aggregating and routing services for existing merchant and issuing banks. In one embodiment, a monitoring system hosted by the service provider interacts and monitors transactions at the issuing bank. Such monitoring may occur as an acquiring bank transmits requests for payment. When a request comes to the issuing bank on an account registered with the service, that request may be flagged by the monitoring system. This is shown at a step 5a of FIG. 2. The monitoring system may view each transaction, and if flagged, may round-up the transaction amount to a certain increment. In one embodiment, this does not affect the payment of goods—the merchant receives funds from the acquiring bank by way of the issuing bank along normal channels. At the issuing bank, however, the sum total of the transaction may be more than what the merchant receives. In one embodiment of the present invention, the enrollee may select to round-up the transaction amount to the next dollar increment—$1.50 becomes $2.00, with $1.50 going to the merchant and $0.50 allocated for investment. In another embodiment, the enrollee may select to round-up the transaction amount to the next $5.00 increment—$1.50 becomes $5.00, with $1.50 going to the merchant and $3.50 allocated for investment. In yet another embodiment, the amount of round-up may be tied to a percentage of a transaction, rather than a dollar multiple. The round-up calculation may be selected by the enrollee at registration or enrollment, or may be set by the issuing bank, or by the service provider. This calculation may be changed, according to one embodiment.

One will appreciate that while FIG. 2 depicts an embodiment of the present invention interacting with the issuing back, in another embodiment, the service feature of the present invention may interact with the regional processor, national processor, issuer processor, acquirer processor, merchant acquiring bank or with any entity that is part of the transaction flow. The flexibility of the present invention allows for variations of embodiments of the present invention.

At some interval, which may be periodic, daily or in real-time, the difference between the actual transaction amount and the rounded-up amount will be transferred to a savings or investment account. The enrollee may have more than one account to distribute to. In FIG. 2, at a step 7, the service provider may initiate transfer of the funds to such asset management firms as Charles Schwab, JP Morgan Chase, or Bank of American investment Services. One will appreciate that transfer can be electronic.

One skilled in the relevant are will appreciate that any number of investment services are available to work with the present invention, and any percentage allocation of funds may be available to the enrollee. For example, in one embodiment, funds may be distributed to a single asset management firm affiliated with the issuing bank. Once transferred, those funds may be made available for investment. As an added incentive, the receiving institution may match the transferred amount in whole or a percentage of the whole amount. In another embodiment, funds may be distributed to another person or entity, where the receiving person or entity may either know or not know of the funds' origin—the funds could be a gift from a known giver or anonymous. In another embodiment of the present invention, funds may be distributed to a charity account, or distributed to a fund held for a specific purpose. In one embodiment, a group of enrollees can designate distribution to a single fund such that the fund can be used to achieve a specific financial goal, such as a family vacation or a new automobile. In another embodiment, funds may be distributed to an existing credit account, such as automated auto, mortgage or other loan payments. One will appreciate that funds may be diverted for any purpose without departing from the spirit of the present invention.

Distribution and transfer of round-up funds can occur at the conclusion of each transaction, or can be aggregated such that funds are transferred at the end of the business day. In another embodiment, funds are transferred when a certain sum amount is reached. For example, funds may be transferred to an investment account if the rounded-up funds reaches $10. This amount may be set by the enrollee or by the service provider.

Other embodiments of the present invention may include the use of other financial accounts besides debit cards. The use of a credit card or checking account may also be used with the automated investment service. Online bill payment may be used as a vehicle for automated investment. Payments may be made in the usual fashion, with additional credit card charges or checking debits added to bring the transaction amount to the preset increment level. The difference between the amount owed to the acquiring party and the incremented sum may be allocated for distribution to an investment or other financial account.

Several exemplary embodiments of the present invention have been disclosed and specifically described herein. One will appreciate that these embodiments are merely exemplary, and that variations and modifications to the present invention are covered by the disclosure above and the claims below, and do not depart from the spirit and intended scope of the present invention.

What is claimed is:

1. System comprising:
a processor for tracking transactions requesting payment for a transaction amount sent for approval from a point of sale device;
a processor for rounding up the transaction amount by adding a preset increment amount to obtain a rounded-up amount;
a processor for routing the difference between the rounded-up amount and the transaction amount to the investment account.

2. The system of claim 1, wherein the processor for tracking transactions tracks transactions as they are received at an issuing bank.

3. The system of claim 1, wherein the processor for tracking transactions for tracking transactions tracks transactions as they are received at a merchant acquiring bank.

4. The system of claim 1, wherein the preset increment amount is a multiple of one whole dollar.

5. A computer program product encoded in a computer-readable medium containing instructions comprising:
receiving, from a point of sale processor, a request for payment authorization for a transaction amount from a pre-registered account;
adding a preset increment amount to the transaction amount to obtain a rounded-up amount; and
routing a difference between the rounded-up amount and the transaction amount to an investment account.

6. The computer program product of claim 11, further comprising instructions for ensuring that the rounded-up amount does not exceed the available funds in the account from which the rounded-up amount will be transferred.

7. A process comprising:
receiving, from a point of sale processor, a request for payment authorization for a transaction amount from a pre-registered account;
adding a preset increment to the transaction amount to obtain a rounded-up amount; and
routing a difference between the rounded-up amount and the transaction amount to an investment account.

8. The process of claim 8, wherein the difference between the rounded-up amount and the transaction amount is added to additional funds before routing the difference to the investment account.

9. A process of processing a first financial transaction of a first person comprising:
determining an investment amount based on at least the first financial transaction;
debiting the investment amount from a source account of the first person; and
crediting at least a part of the investment amount to a first recipient account of a second person.

10. The process of claim 9, wherein the crediting at least a part of the investment amount comprises:
crediting a first percentage of the investment amount to the first recipient account; and
crediting a second percentage of the investment amount to a second recipient account.

11. The process of claim 9, wherein debiting the investment amount occurs on a daily basis and is based on an aggregate investment amount from a plurality of financial transactions.

12. The process of claim 11, further comprising: determining if adequate funds are available in the source account before debiting the investment amount.

13. The process of claim 9, wherein the investment amount is determined by adding a preset increment to the value of the financial transaction to obtain a rounded-up amount, and the investment amount is equal to the difference between the rounded-up amount and the value of the financial transaction.

14. The process of claim 9, further comprising crediting a matched amount to the first recipient account.

15. The process of claim 14, further comprising determining whether a matching program is still in effect before crediting.

16. The process of claim 9, further comprising providing an identity of the first person to the owner of the second recipient account as a source of the investment amount.

17. A process comprising:
executing a financial transaction for a first account;
calculating an investment amount based on the financial transaction;
debiting the investment amount from the first account;
crediting a first portion of the investment amount to a second account; and
crediting a second portion of the investment amount to a third account.

18. The process of claim 17, wherein the first account and the second account are owned by different entities.

19. The process of claim 17, wherein the debiting the investment amount occurs on a daily basis and is based on an aggregate investment amount from a plurality of financial transactions.

20. The process of claim 17, further comprising determining if adequate funds are available in the first account before debiting the investment amount.

21. The process of claim 17, wherein the investment amount is determined by a rounding up the value of the financial transaction by adding a preset increment to obtain a rounded-up amount, and the investment amount is equal to the difference between the rounded-up amount and the value of the financial transaction.

22. The process of claim 17, further comprising crediting a matched amount to the second account.

23. The process of claim 22, further comprising determining whether a matching program is still in effect before crediting.

24. The process of claim 17, further comprising providing an identity of the first person to the owner of the second recipient account as a source of the investment amount.

25. The process of claim 17, wherein the preset increment increases the value of the financial transaction to the nearest whole dollar amount.

26. A computer program product encoded in a computer-readable medium containing instructions comprising:
determining an investment amount based on at least a first financial transaction;
debiting the investment amount from a source account of a first person; and
crediting at least a part of the investment amount to a first recipient account of a second person.

27. The computer program product of claim 26, wherein the credit at least a part of the investment amount comprises:
crediting a first portion of the investment amount to the first recipient account; and
credit a second portion of the investment amount to a second recipient account.

28. The computer program product of claim 26, wherein debiting the investment amount occurs daily based on an aggregate investment amount from a plurality of financial transactions.

29. The computer program product of claim 26, the instructions further comprising determining if adequate funds are available in the source account before debiting the investment amount from the source account of the first person.

30. The computer program product of claim 26, wherein the investment amount is determined by adding a preset increment to the value of the financial transaction to obtain a rounded-up amount, and the investment amount is equal to the the difference between the rounded-up amount and the value of the financial transaction.

31. A process comprising:
determining an investment amount based on at least the first financial transaction;
debiting the investment amount from a source account of the first person;
crediting a first portion of the investment amount to a first recipient account; and
crediting a matched amount to the first recipient account.

32. The process of claim 31, further comprising determining whether a matching program is still in effect before crediting.

33. The process of claim 31, further comprising crediting the matched amount only if it is determined that the first financial transaction is eligible to be matched.

34. The process of claim 31, further comprising crediting the matched amount only if it is determined that a predetermined time period has not been surpassed.

35. The process of claim 31, wherein the matched amount approximately equals the investment amount.

36. The process of claim 31, wherein the matched amount equals a predetermined amount.

37. The process of claim 31, wherein the first recipient account is owned by a second person.

38. The process of claim 31, further comprising crediting a second portion of the investment amount to a second recipient account.

39. The process of claim 31, wherein debiting the investment amount occurs daily basis based on an aggregate investment amount from a plurality of financial transactions.
